(19) United States
(12) Patent Application Publication
(10) Pub. No.: US 2026/0104534 A1
(43) Pub. Date: Apr. 16, 2026

(54) SUB-MILLIMETER AND TERAHERTZ FREQUENCY METAMATERIAL FLAT LENS

(71) Applicants: Cassandra Whitton, Tempe, AZ (US); Philip Mauskopf, Scottsdale, AZ (US); Christopher Groppi, Phoenix, AZ (US)

(72) Inventors: Cassandra Whitton, Tempe, AZ (US); Philip Mauskopf, Scottsdale, AZ (US); Christopher Groppi, Phoenix, AZ (US)

(21) Appl. No.: 18/917,906

(22) Filed: Oct. 16, 2024

Related U.S. Application Data
(60) Provisional application No. 63/590,705, filed on Oct. 16, 2023.

(51) Int. Cl. G02B 1/00

(52) U.S. Cl. CPC G02B 1/002

(57) ABSTRACT

A metamaterial flat lens having one or more dielectric layers and one or more metal layers. Each of the one or more metal layers is disposed on one of the one or more dielectric layers or between two of the one or more dielectric layers. Each of the one or more metal layers has a regularly spaced pattern of metal features. The metal features differ in size, and each metal feature in each of the one or more metal layers is aligned with corresponding metal features in the other one or more metal layers if present to define a pixel having a thickness of the lens. The lens comprises a multiplicity of pixels, with each pixel of the multiplicity of pixels having a side length in the plane of the lens based on the free-space wavelength of the light to be focused. The light to be focused has a frequency of at least 480 GHz.

### CROSS-REFERENCE TO RELATED APPLICATION

This application claims the benefit of U.S. Patent Application No. 63/590,705, filed on Oct. 16, 2024, which is incorporated herein by reference in its entirety.

### STATEMENT OF GOVERNMENT SUPPORT

This invention was made with government support under 80NSSC22K1899 awarded by the NASA Shared Services Center. The government has certain rights in the invention.

### TECHNICAL FIELD

This invention relates to a metamaterial flat lens suitable for operation at sub-mm and low terahertz frequencies.

### BACKGROUND

Quasioptics is the study of systems that can be used to focus light in regimes where traditional geometric optics break down due to the wavelengths of light approaching the size of the focusing object in scale. In practice, this means quasioptics are often applicable from microwave to nearterahertz frequencies. Most such quasioptical focusing elements are made using traditional curved lenses: that is, lenses that diffract the light and focus it by varying the thickness of the lens. These lenses may be made out of a variety of materials, such as silicon or high-density polyethylene. Because of the thickness of such lenses, and the tendency of materials to be lossy at quasioptical frequencies, materials must be chosen carefully in order to ensure the lens is not too lossy. In general, the more power the lens can focus to its focal point, the better. In addition, these lenses often benefit from anti-reflection coating which reduces losses from light reflecting off the surface of the lens.

### SUMMARY

This disclosure describes a metamaterial flat lens that can operate at sub-mm and low terahertz frequencies. In particular, this disclosure describes a lightweight and thin apparatus to focus a bandwidth of light within the sub-millimeter to terahertz-frequency range (i.e., light from 20 GHz or 480 GHz to 1 THz) using patterned metal elements embedded within a dielectric substrate.

In a general aspect, a metamaterial flat lens having one or more dielectric layers and one or more metal layers. Each of the one or more metal layers is disposed on one of the one or more dielectric layers or between two of the one or more dielectric layers. Each of the one or more metal layers has a regularly spaced pattern of metal features. The metal features differ in size, and each metal feature in each of the one or more metal layers is aligned with corresponding metal features in the other one or more metal layers if present to define a pixel having a thickness of the lens. The lens comprises a multiplicity of pixels, with each pixel of the multiplicity of pixels having a side length in the plane of the lens based on the free-space wavelength of the light to be focused. The light to be focused has a frequency of at least 480 GHz.

Implementations of the general aspect may include one or more of the following features.

Each of the one or more dielectric layers is composed of a low-loss dielectric material (e.g., polypropylene, polyimide, or cyclic-olefin copolymer). A thickness of each of the one or more dielectric layers is in a range of about 1 micron to about 20 microns.

The metal features are periodic arrays of metal squares or rectangles. The metal features are typically composed of aluminum copper, gold, or silver. A thickness of each of the one or more metal layers is typically in a range of 0.1 micron to 0.3 microns. The dimension in the plane of the one or more metal layers is ¼ to ⅙ (e.g., ⅕) of the free-space wavelength of the light to be focused.

A total number of the one or more dielectric layers and the one or more metal layers is typically in a range of 2 to 25. A total number of the metal layers can be equal to or less than the total number of the dielectric layers. In one example, a total number of the metal layers is 10, a total number of the dielectric layers is eleven, and each of the one or more metal layers is disposed between two of the dielectric layers.

The light to be focused has a frequency of up to 1 THz. Each of the metal features has a side length of 1% to 99% of the side length of the pixels. A diameter of the lens is typically in a range of about 100 mm to about 600 mm. A thickness of the lens is typically in a range of about 50 microns to about 500 microns (e.g., about 50 microns to about 200 microns, or about 50 microns to about 150 microns).

The metamaterial lens is flexible, and can be secured in a frame.

The metamaterial flat lens described herein can work at frequencies at least as high as 480 GHz. It is less than 500 μm (e.g., less than 200 μm) thick and weighs roughly one hundredth of a traditional curved lens design. It has a total efficiency, including dielectric loss, reflective loss, and optical loss, of over 50%, with built-in anti-reflective coating. It can be produced as large as 300 mm in diameter or 600 mm in diameter and likely larger with sufficient manufacturing capabilities. It can be produced with f-numbers as low as 1.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A is a cross-sectional side view of a portion of a metamaterial flat lens according to examples of the present disclosure. FIG. 1B is a side perspective view of a portion of a metamaterial flat lens. FIG. 1C is a top view of a patterned metal feature in a metamaterial flat lens.

FIG. 2 is a top view of an enlarged portion of a metamaterial flat lens, showing patterned metal features.

FIG. 3 shows an exemplary metamaterial flat lens in a frame.

### DETAILED DESCRIPTION

This disclosure relates to a metamaterial lens for operation at sub-mm and low terahertz frequencies. The lens is manufactured by using metamaterial structuring that emulates the electromagnetic qualities of a lens. This lens may be much thinner than a curved lens, which means less dielectric loss and less weight. It can be made through Fourier optics simulations to produce the lens phase pattern. The resulting lenses are thinner and lighter with an anti-reflection coating and can operate at higher frequencies at a large diameter with a shorter focal length.

Metamaterial technology is, effectively, the use of features that are sub-wavelength in size, intentionally applied, to affect electromagnetic fields (and thus light) in a particular way. In practice, two ways to do this are subtractive (e.g., removing small pieces of dielectric from dielectric structure) or additive (e.g., adding small metal elements to a dielectric structure). Instead of using a curved lens, a flat lens may be created by using metamaterial structuring that emulates the electromagnetic qualities of a lens. This lens may be made much thinner than a curved lens, which means less dielectric loss and less weight, and metamaterials can also sometimes be used to provide virtual anti-reflection coating, reducing reflective loss.

In comparison to traditional curved lenses, metamaterial lenses described herein are thinner and lighter (e.g., a factor of 100 less in weight). In addition, lenses described herein effectively contain anti-reflection coating that reduce losses compared to traditional lenses. These advantages are well-suited for space missions where light weight and maximum power collection are paramount. These lenses operate at higher frequency than other metamaterial lenses of similar diameter, and have a shorter focal length than other lenses of similar diameter.

Once a lens has been designed and simulated, the dimensions of the patterned metal layers and separation between the layers and number of layers are selected given a particular substrate. Example substrates include polypropylene, polyimide, or cyclic-olefin copolymer. Grid designs are then simulated using a 3D electromagnetic design solver such as Ansoft HFSS. Once the design is fixed, the lens can be fabricated by depositing metal (e.g., copper or aluminum) onto a thin dielectric substrate, patterning the metal layer and etching the pattern using standard photolithography and then depositing a dielectric spacing layer using spin coating and then repeating the process until all the layers are completed.

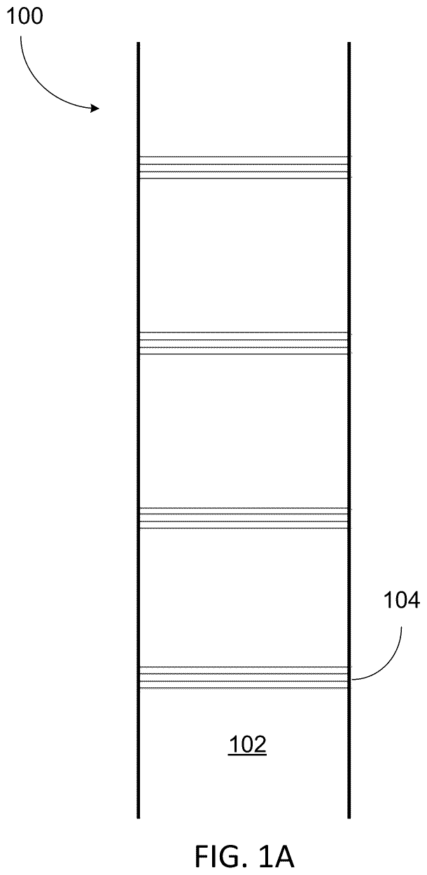

FIG. 1A shows cross-sectional side view of a portion of metamaterial flat lens 100 according to examples of the present disclosure. The lens includes alternating layers of a dielectric film and a spaced pattern of metal features. The number of alternating layers shown in FIG. 1 is a non-limiting example and can be varied depending on the application for which the lens is used. The lens 100 includes alternating dielectric film layers 102 and patterned metal layers 104. Each patterned metal layer 104 is formed on a top surface of a dielectric film layer 102. Additional structural details are provided in WO2024118937A1, which is incorporated herein by reference in its entirety. FIG. 1B shows a perspective view of a portion of metamaterial flat lens 100 with metal features 106 between dielectric film layers 102, forming a portion of a single pixel or transmission line 108. FIG. 1C is a top view of metal feature 106 from transmission line 108. Metal feature 106 is a square having a side length S arranged in an area having a side length of p and spaced apart from other metal features in patterned metal layer 104. Other shapes may be used depending on the application for which the filter is used, the manufacturing process used to make the filter, etc. The metal features can include gold, silver, or copper.

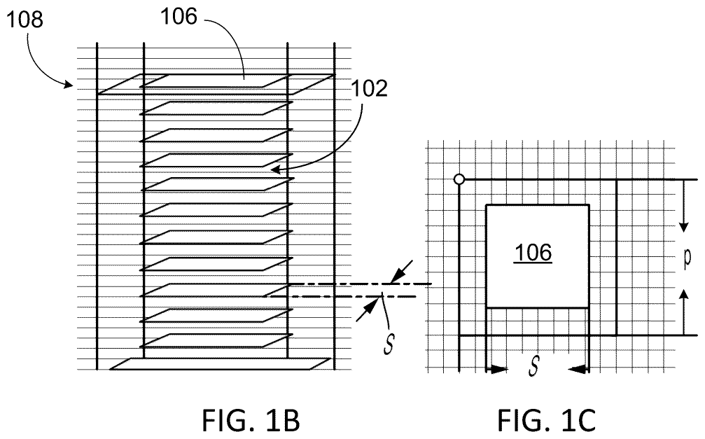

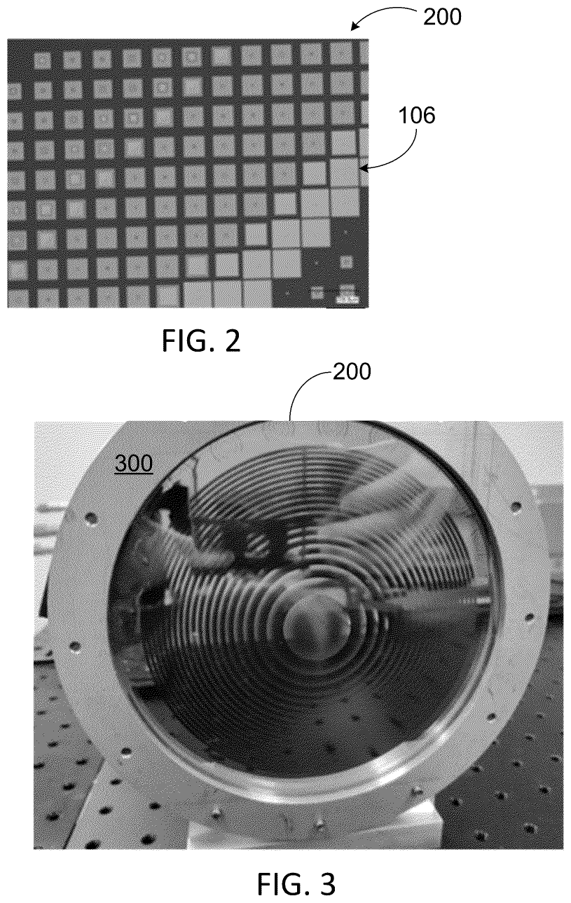

FIG. 2 is a top enlarged view of a portion of a metamaterial lens 200 having spaced apart metal features 106 spaced apart. Metal features 106 are spaced apart squares having different side lengths. FIG. 3 depicts metamaterial lens 200 mounted in frame 300.

In summary, examples of the present disclosure provide for use of a quasi-optical (multimode, coupled to free space) multilayer dielectric lens at long wavelengths where the lens makes use of artificial dielectric materials. The present lenses can be used in several areas of commercial potential for these lenses including the use in long wavelength (radio to far-infrared) astronomical instruments both on ground-based and space-based telescopes and in high end radio and millimeter-wave communications downlink receivers.

A lens as described herein may be designed and manufactured as described below.

Primary optical characteristics of the lens (e.g., diameter, focal length, operating frequency) are selected. The diameter may be be constrained by manufacturing capabilities and by system the lens will be used in. The focal length may be constrained by the optical system it is used in, but can be as short as half of the lens diameter.

Materials and secondary characteristics of the lens (dielectric substrate material, conductive material, thickness of dielectric and metal layers, and number of layers) are selected. The dielectric substrate is preferably low loss. Polyimide is a suitable material. The conductive material is preferably as conductive as possible. Copper and aluminum are suitable options. Choosing the number of layers is a trade-off between complexity of the design and performance. More layers means may improve performance but increase complexity. A conductive thickness can be at least two skin depths at the desired operating frequency.

The lens surface is subdivided into pixels (e.g., into a 2D grid of squares in the plane perpendicular to the focal axis) based at least in part on the operating frequency. The subdivision can be a fifth of a wavelength or less.

From the desired optical characteristics, the desired phase transformation that each pixel will apply is selected as a function of frequency. This can be done using Fourier optics to obtain an accurate result. To do this, use Fourier optics can be used to calculate the phase pattern produced at the lens plane by a reasonably coupled horn placed at the desired focal point of the lens. The Fourier optics simulation improves accuracy for lenses where the focal length is comparable to the lens diameter or shorter. Other options include Gaussian approximation instead of Fourier optics.

In HFSS or equivalent EM simulation software), varying sizes of individual conductive elements embedded in dielectric are simulated. This can be done using floquet ports to simulate a plane wave interacting with an infinite periodic structure. This is an approximation of how the element will be used in the actual structure, but is close enough to give strong results. The conductive elements are typically squares or rectangles with side length ranging from zero times the pixel side length to 1 times the pixel side length (e.g., 1% of the pixel side length to 99% of the pixel sidelength). The more that are simulated in this range, the more accurate the model tends to be.

Using the results from HFSS, a model is created that simulates the S-parameters of a single pixel using transmission line theory. This can also involve a model of the dielectric S-parameters, which may be obtained given the dielectric's relativity and tan delta, using a good dielectric approximation. This model will cascade the S-parameters of its constituent parameters: for instance, for a lens with three dielectric layers and two conductive layers, the model would cascade dielectric-conductive element-dielectric-conductive element-dielectric. The dielectric S-parameters are based at least in part on the chosen thicknesses of dielectric material. The size of the conductive elements can be left as free parameters within the model.

In a scripting language, an optimization script is run which tweaks the sizes of the conductive elements in order to find the best element size for each pixel in the lens. The optimization script can optimize over the space of element sizes (each element size independent from the others), and evaluate the result by making calls to the model created as a subroutine. The optimization can seek to maximize the pixel transmittance multiplied by the cosine of the phase error. The optimization is typically constrained by the minimum feature size that can be manufactured.

After each pixel in the lens has been optimized, metal layers can be created by automatically writing each pixel's conductive elements into a photolithographic manufacturing file, such as a gerber file or GDS file.

Once these operations have been performed to design the lens, the lens may be manufactured as follows:

Using a silicon wafer as a base, spin-cast the first layer of the dielectric material. Spin-casting can allow the correct thickness of material to be deposited. Once the material is deposited and cooled, the first conductive layer of the lens may be put on the dielectric using standard photolithographic techniques. Then the next layer of dielectric may be spin-casted overtop of the metal layer, followed by photolithography of the next metal layer, and so on until all metal and dielectric layers have been fabricated. The lens may then be removed from the silicon wafer and mounted as desired.

The lens may be used like any standard lens. If a plane wave is applied to the input of the lens, it can be focused to the focal point of the lens.

Advantages include operation at sub-mm and low terahertz frequencies while at large diameters. The lenses have a total efficiency, including dielectric loss, reflective loss, and optical loss, of over 50%, with built-in anti-reflective coating and a shorter focal length.

An exemplary metamaterial flat lens manufactured as described herein has been shown to operate as high as 480 GHz. This lens demonstrated a Strehl ratio of 0.78. The built-in anti-reflection coating is effective, resulting in only 3.5% reflective loss successfully demonstrated the focusing abilities of the 20 GHz metamaterial flat lens.

In the design of the exemplary lens described herein, the optic orthogonal to the direction of propagation into is divided into small (roughly ⅕ wavelength) cells. Additional details regarding general modelling and optimization techniques are provided in G. Pisano, et al., “Dielectrically embedded flat mesh lens for millimeter wave applications,” Applied Optics, Vol. 52, No. 11, pp. 2218-2225, 2013, and G. Pisano, et al., “Development of large-diameter flat mesh-lenses for millimetre wave instrumentation,” in Millimeter, Submillimeter, and Far-Infrared Detectors and Instrumentation for Astronomy IX, vol. 10708. SPIE, 2018, pp. 16-27, both of which are incorporated herein by reference. Notably, however, the lens described herein has a higher operating frequency, a different focal length and diameter, and is fabricated of different materials.

Each cell of the lens is implemented as a stack of a multiplicity of thin layers including of metallized squares separated by dielectric sheets. The alternating pattern of metallized squares and dielectric sheets along the propagation direction forms a free space transmission line (TL) that can be modeled and optimized using transmission line theory. This TL is designed to provide the desired phase shift at a given spatial location in the optic, while also optimizing transmission through the structure, so that the property of anti-reflectance is intentionally designed into each TL.

### Lens Design

The design of the lens proceeds in stages. First, an ideal lens phase pattern is created depending on the operation frequency, focal length, and diameter of the lens. This phase pattern is then subdivided into pixels sized according to the metamaterial structure employed in the lens. A library of meta-atoms is then created and simulated: each meta-atom in this structure is a single metal square. Then, using this simulated library of meta-atoms, optimizations are performed to create pixels in the lens structure which approximate the ideal phase pattern as closely as possible. Each pixel includes alternating layers of dielectric and meta-atom, and the lens structure includes alternating layers of dielectric and metal patterned grids. This lens structure is then converted into manufacturing files, and the metamaterial lens is created by building up alternating layers of solid polyimide dielectric and patterned metal using photolithography.

Phase Design. The lens described herein acts as a converging lens: that is, it turns an incoming plane wave (such as light from a distant point source) into a converging spherical wave that will focus at the focal point of the lens. The lens can do this by applying a phase shift to the wave as a function of distance from the lens center.

In one example, a 124 mm-diameter lens which performs at 480 GHz was fabricated. In this example, the design builds up polyimide using spin-casting followed by patterned aluminum in alternating layers, allowing for very precise top-to-bottom alignment. Because of the relatively long wavelength of 480 GHz light, the focal point is not truly a point as would be the case in optics. Rather, the system is a quasioptical one. In this regime, a converging wave can be approximated using a gaussian beam. The reciprocal and mathematically equivalent situation of propagating a beam from the focus of the lens to its surface is also explored. In this case, a virtual gaussian beam waist is placed at the focal plane of the lens. The beam waist chosen was equal to ω₀=2λf(πd), where f is the focal length, d is the diameter of the lens, and λ is the free-space wavelength of the light to be focused. Propagating this virtual beam a distance of f to the lens surface, the phase of the propagated wave is:

$$ϕ ( r ) = \frac{π {r}^{2}}{λ R} \qquad ( 1 )$$

$$where$$

$$R = f + \begin{matrix}\underline{1} \\ f\end{matrix} \frac{{{πω}_{0}}^{2}}{λ} \qquad ( 2 )$$

and r is the distance from the lens center to the position in question on the lens surface. Applying these equations to the lens specifications (led to an ideal phase pattern.

Metamaterial Optimization. In one example, a 150 mm diameter with a 150 mm focal length (f-number of f/1.19) and an operating frequency of 480 GHz was fabricated. First, the ideal phase pattern was subdivided into square pixels with a dimension of λ/5, or p (119.9 microns at 480 GHz). Next, the metamaterial structure was chosen. A structure with layers of patterned metal squares (that is, layers consisting of many meta-atoms of varying sizes) embedded within layers of dielectric material was used. The dielectric material chosen was polyimide. The metal chosen was aluminum, which can be patterned with a dry-etch process.

This example lens was designed with 11 dielectric layers of 10 μm thickness each, giving a total thickness of roughly 115 μm (after adding metal layers between). This resulted in 10 patterned metal layers in between. The metal layers were 0.2 μm in thickness. The patterned metal layers were then be optimized to emulate the ideal phase pattern.

In order to do this, first, meta-atoms of 99 different sizes were simulated in HFSS. The parameter being changed in this case is s, the lengths of the sides of the square, from 1% of p to 99% of p, in 1% increments. The meta-atom consisted of a single finite-thickness, finite-conductivity aluminum square embedded in polyimide. The polyimide was assumed to have ϵᵣ=3.5 and tan δ≈0.015. Floquet ports were used to simulate a plane wave entering and exiting an infinite periodic structure of identical meta-atoms, with a period equal to the pixel size of the metamaterial. While this does not exactly represent the physical situation present in the lens, because the sizes of the squares vary by position, it was deemed to be close enough since typically the metal square sizes vary slowly except at phase-wrap boundaries. The two-port S-parameters of each of the 99 meta-atoms were de-embedded to the top and bottom surfaces of the metal square. The S-parameters were calculated from 450 GHz to 500 GHz, to allow the performance of the lens to be simulated at multiple frequencies.

These meta-atoms have electrically simple structures, varying little as a function of frequency. It can also be seen that small meta-atoms (such as the 20% case) reflect very little signal, while large ones (such as the 95% case) reflect almost all of the signal. The 70% case reflects roughly half of the signal, which seems intuitive due to the fact that it fills roughly half the available area of its pixel-grid unit cell. The reflected and transmitted phases can be seen to each vary by slightly less than 90 degrees over the range of meta-atoms shown.

The S-parameters of each of the 99 meta-atoms were exported as touchstone files and then imported into a Matlab program. This allows modeling of each pixel in the lens as a transmission line (TL), consisting of 11 layers of polyimide dielectric and 10 layers of metal squares. The S-parameters for the polyimide layers were calculated analytically. Given S-parameters of both the polyimide layers and meta-atoms, the S-parameters of a full stack, or TL, for any combination of 10 different sizes of meta-atoms, could be calculated using cascaded transmission line theory. First, the S-parameters were converted to ABCD parameters. There are formulas to accomplish this, but we elected to use subroutines in Matlab's RF Toolkit. Then, the ABCD parameters were cascaded by matrix-multiplying them together. Finally, the ABCD parameter for the full TL was converted back into S-parameters, using the characteristic impedance of free space as the S-parameter reference impedance.

Given this model, which can effectively take as varying inputs the sizes of the meta-atoms and give as output the S-parameters of the resulting TL, an optimizer can be straightforwardly used to obtain the ideal phase pattern for the lens. Because the S-parameters of the individual meta-atoms are pre-calculated, there is no need to resimulate anything using a full-wave simulator such as HFSS during the optimization process. Because of this, a TL can be optimized in seconds, whereas an optimization relying on full-wave simulations could take weeks or months or even more. It was assumed that the sizes of the meta-atoms would be top-to-bottom symmetrical, to reduce the number of free parameters in each optimization from 10 to 5.

The optimizer was constrained such that it could not change the side-length s of any square to be smaller than 5 μm or larger than 114.9 μm (which is equal to p=119.9 μm minus the 5 μm minimum feature size).

The goal function for the optimization was

$$\vert {S}_{21} \vert cos ( {ϕ}_{ideal} - ang ( {S}_{21} ) ) \qquad ( 3 )$$

where φ_{ideal} is the ideal phase. Thus φ_{ideal}−ang(S₂₁) represents the phase error of the TL and |(S₂₁)| represents the transmission magnitude. Note that because the transmission magnitude is included in the optimization function, an optimized TL will generally have anti-reflective properties.

Because our lens was a single-frequency design, we elected to optimize 60 TLs ranging from phase shifts of 0 to 360 degrees. After this optimization, each pixel in the lens was assigned the TL which was closest to its ideal phase shift. The phase error never goes above 25 degrees for any TL at the design frequency, and the transmittance is never below −2.5 dB. Then, each pixel in the lens was assigned to TL which was closest to its ideal phase shift.

Finally, the meta-atoms were laid out into a 10-layer GDSII manufacturing files so that they could be fabricated.

Manufacturing. The polyimide (PI) based lens film stack is comprised of multiple independently coated layers of PI patterned with aluminum metal. The PI resin, in this case, is spin coated to a required thickness then cured. The cure was performed in a Despatch nitrogen curing oven at a temperature of 300° C. As the PI/metal stacks are built up, there is a slight increase in the bow and warp of the substrate stack. This bow and warp increases as the total number of stacks are increased.

Each independently coated PI layer has a unique metal pattern. The PI is coated with a thin etch stop layer. Aluminum metal 200 nm thick is sputter deposited on the etch stop layer and patterned using alignment keys provided on the back of the wafer. The metal is dry etched for critical dimension (CD) control and the photoresist is removed via oxygen plasma.

Once all of the independent PI layers have been fabricated, the stacked PI is then debonded from the carrier. No curling is seen with the film stack and the individual polyimide layers have excellent adhesion within the stack. The debonded stack is still quite flexible but structurally stable.

### Lens Characterization

Simulations. Theoretical simulations of the lens were performed in order to provide a baseline of comparison. These simulations were based on the as-optimized model of the lens, and thus included the phase errors, reflection losses, and material losses of the optimized pixels.

These simulations assumed that the lens could be modeled using the same method as used in the optimization and design process. In other words, the lens surface was subdivided into pixels that were each one metamaterial grid element in size. Each pixel was then modeled as a transmission line of cascaded polyimide and aluminum meta-atom layers, with the polyimide assumed to have a relative permittivity of 3.5 and a tan δ of 0.015, and the meta-atom layers modeled using a full-wave Floquet port simulation in HFSS.

In order to model the loss of the lens, a plane wave was generated across the pixels of the lens surface and then trans-formed, pixel-wise, by the S21 of each pixel's transmission line. The power of the lens output field was divided by the power of the input field (truncated to only include the lens's surface) in order to give an effective gain, which can then be easily converted to a loss. The power of the S11 field was also compared in the same way, in order to determine how much of the theoretical lens loss was due to reflective loss as opposed to material loss within the lens.

To model the far-field beam pattern of the lens, first a field was generated that emulated the near-field probe used to illuminate the lens in the near-field scan measurement. This field was modelled as the TE10 mode of −2.2 waveguides, which are the waveguides used by the VNA extenders employed in the testing. The mode's fields were modeled and then sampled using the pixel gridding employed by the lens surface.

Once the field was sampled, it was propagated a distance of one focal length, or 15 cm. This propagation was performed using the angular plane wave spectrum (APWS) representation. This propagated field was then transformed, pixel-wise, using the S21 of the lens pixels. This generated an output field for the lens, to which the APWS method could be applied again to approximate the far-field beam pattern of the lens as illuminated by the waveguide.

Measurement Setups. Two primary methods of measurement were used to characterize the lens performance. The first method was a 2d near-field scan and the second was a radiometric loss measurement.

Near-Field Scan: To perform the near-field scan, the lens was mounted one focal distance from a near-field probe, acting as the lens feed. The near-field probe is a WR-2.2 open-ended waveguide on a conical tip, such that the lens is near-uniformly illuminated with a field edge tapering less than 1.65 dB. The lens itself was mounted within an aluminum ring holder. Due to the flexibility of the lens, the lens was not held perfectly flat by the mount; rather it was slightly bowed in its center. However, it was reasoned that this wouldn't affect the measurement quality drastically due to the fact that, for a lens, phase-errors generated by a slight curve should cancel to first order.

A WR-2.2 diagonal horn antenna was positioned roughly 10 cm on the opposite side of the lens face as a near-field measurement probe, and mounted on a 2D automated stepper stage, such that the probe could be moved in the plane parallel to the lens plane. Both the lens feed and measurement probe were connected to a Virginia Diodes 325-500 GHz VNA extender, which in turn were connected to a VNA. The VNA and stepper stage were connected to a computer control system, allowing the scan to be automated. Absorbers were placed right behind the probes in order to minimize reflections.

Rough scans through the E- and H-planes were performed to align the illuminating probe in the focal direction. This was done by observing the curvature of the output phase at the lens's center frequency of 480 GHz. Once the output phase was approximately flat in both planes, the system was considered to be properly focused.

Once focused, full 2D scans were performed, measuring both transmission and phase across the lens surface. The scan was performed at a resolution of 0.65 mm, which is equivalent to approximately one free-space wavelength. The data were recorded and stored for later processing.

Radiometric Loss Measurement: The radiometric loss measurement used a diagonal horn connected to a 1100K receiver designed and built at JPL that operates in the frequency range of our lens. This receiver, which was a heterodyne mixer, was fed by a signal generator in order to down-convert the received signal into an intermediate frequency of 4-8 GHz. The down-converted signal was sent into a 4-8 GHz band-pass filter and then measured by a power detector.

The lens was mounted in the same aluminum ring holder as in the near-field scan experiment. The flatness of the lens was not perfect, but it was reasoned that this would not substantially impact the results.

The horn was placed at approximately the focus of the lens. The power was then measured from the power detector in two configurations: one with a room-temperature absorber immediately below the lens; and one with a dewar of liquid nitrogen (LN2), with an absorber at the bottom, immediately below the lens. These two measurements in tandem are a Y-factor measurement, which allows the equivalent noise temperature of the lens-horn-receiver system to be measured.

This Y-factor measurement was then repeated, but with the lens removed. This gives a measurement of the noise temperature of the horn-receiver system.

Given these two measurements, the noise temperature of the lens alone can be de-embedded. Then the loss factor of the lens can be calculated by rearranging the following equation

$$L = 1 + \frac{{T}_{e}}{1} \qquad ( 4 )$$

where Tₑ is the equivalent noise temperature of the lens and Tis the physical lens temperature, assumed to be room temperature at the time of measurement.

This loss measurement was performed at a range of frequencies from 460 to 500 GHz, in steps of 5 GHz.

Results. The data obtained from the near-field scan were processed to obtain a far-field beam pattern using standard complex near-to-farfield transformations. Preceding this transformation any linear phase ramp present in the 2D planar measurement, caused by the antenna and measurement plane not being perfectly parallel, was removed. This correction centers the beam in our coordinates system without changing the beam shape or properties.

It is clear that the far-field beam pattern measured in the lab very closely matches the theoretical expectation. The largest discrepancies are deviations of a few dB in the sidelobe levels.

The maximum directivity of the beam as a function of frequency was also plotted and is shown in FIG. 9b. At the measurement frequencies nearest to 480 GHz, the directivity is less than 0.3 dB away from being diffraction-limited. This indicates a very good phase match at these frequencies. The 3 dB bandwidth of the directivity is just over 20 GHz, or about 4%. It can be seen that the measured directivity matches the simulated expectations quite well, even exceeding the simulations slightly at lower frequencies.

This bandwidth is limited, but this is expected due to the single-frequency design method employed in creating the lens. This can likely be improved significantly using broad-band phase optimization and a longer focal length. In addition, the phase patterns away from the center frequency appear roughly spherical. This likely indicates that the effective bandwidth can be increased if refocusing the feed horn is possible.

The combined reflective and transmissive loss is roughly 2.5 dB at the design frequency and only varies by about ±0.2 dB over the measured band. This is significantly higher than the expected loss of the lens, which our simulations predicted to be 1.0. Of this 1.0 dB of simulated loss, approximately 0.2 dB is reflective loss, 0.5 dB is conductive loss, and 0.3 dB is dielectric loss.

It was speculated that the loss could be attributed to over- or under-etching of the aluminum pattern, which might result in poor anti-reflection matching. A measurement of the reflection from the lens surface could be very useful in diagnosing this issue, though it is difficult to accomplish.

Thus, a flat metamaterial 480 GHz lens with a diameter of 124 mm designed, fabricated, and tested. The design employed optimization of 10 layers of meta-atoms to match a desired phase output. The manufacturing process made use of spin-casted polyimide in combination with photolitographically etched aluminum. The lens weighs 3.0 grams, significantly less than a comparable conventional lens.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A metamaterial lens comprising:
one or more dielectric layers; and
one or more metal layers, each of the one or more metal layers is disposed on one of the one or more dielectric layers or between two of the one or more dielectric layers, each of the one or more metal layers comprising a regularly spaced pattern of metal features, wherein the metal features differ in size, and each metal feature in each of the one or more metal layers is aligned with corresponding metal features in the other one or more metal layers if present to define a pixel having a thickness of the lens, the lens comprising a multiplicity of pixels, with each pixel of the multiplicity of pixels having a side length in the plane of the lens based on the free-space wavelength of the light to be focused,
wherein the light to be focused has a frequency of at least 480 GHz, and the lens is flat.

2. The metamaterial lens of claim 1, wherein each of the one or more dielectric layers comprises a low-loss dielectric material.

3. The metamaterial lens of claim 2, wherein the low-loss dielectric material comprises polypropylene, polyimide, or cyclic-olefin copolymer.

4. The metamaterial lens of claim 3, wherein the low-loss dielectric material comprises polyimide.

5. The metamaterial lens of claim 1, wherein a thickness of each of the one or more dielectric layers is in a range of about 1 micron to about 20 microns.

6. The metamaterial lens of claim 1, wherein the metal features are periodic arrays of metal squares or rectangles.

7. The metamaterial lens of claim 1, wherein the metal features comprise aluminum copper, gold, or silver.

8. The metamaterial lens of claim 7, wherein the metal features comprise aluminum.

9. The metamaterial lens of claim 1, wherein a thickness of each of the one or more metal layers is in a range of 0.1 micron to 0.3 microns.

10. The metamaterial lens of claim 1, wherein the dimension in the plane of the one or more metal layers is ¼ to ⅙ of the free-space wavelength of the light to be focused.

11. The metamaterial lens of claim 10, wherein the dimension in the plane of the one or more metal layers is ⅕ of the free-space wavelength of the light to be focused.

12. The metamaterial lens of claim 1, wherein a total number of the one or more dielectric layers and the one or more metal layers is in a range of 2 to 25.

13. The metamaterial lens of claim 1, wherein a total number of the metal layers is equal to or less than the total number of the dielectric layers.

14. The metamaterial lens of claim 1, wherein a total number of the metal layers is 10, a total number of the dielectric layers is eleven, and each of the one or more metal layers is disposed between two of the dielectric layers.

15. The metamaterial lens of claim 1, the light to be focused has a frequency of up to 1 THz.

16. The metamaterial lens of claim 1, wherein each of the metal features has a side length of 1% to 99% of the side length of the pixels.

17. The metamaterial lens of claim 1, wherein a diameter of the lens is in a range of about 100 mm to about 600 mm.

18. The metamaterial lens of claim 1, wherein a thickness of the lens is in a range of about 50 microns to about 500 microns.

19. The metamaterial lens of claim 1, wherein the lens is flexible.

20. The metamaterial lens of claim 1, wherein the lens is secured in a frame.
